(19) United States
(12) Patent Application Publication
(10) Pub. No.: US 2005/0261944 A1
(43) Pub. Date: Nov. 24, 2005

(54) Method and apparatus for detecting the erroneous processing and adjudication of health care claims

(76) Inventor: Ronald Lee Rosenberger, Rome, GA (US)

Correspondence Address: GREENBERG TRAURIG, LLP, 77 WEST WACKER DRIVE, SUITE 2500, CHICAGO, IL, 60601-1732, US

(21) Appl. No.: 11/136,209

(22) Filed: May 24, 2005

Related U.S. Application Data
(60) Provisional application No. 60/573,917, filed on May 24, 2004.

(51) Int. Cl. G06F 17/60

(52) U.S. Cl. 705/4; 705/2

(57) ABSTRACT

An automated data processing systems and associated method for detecting and reporting the erroneous processing and adjudication of heath care claims and resulting payments made to a heath care provider by one or more third parties, such as medical insurance companies. A rules engine applies business logic to compare an electronic representation of a claim, an electronic representation of a payment and an associated explanation of benefits, with an electronic representation of contractual terms to determine any discrepancies between the electronic representation of the claim and the electronic representation of the payment and the explanation of benefits in relation to the electronic representation of the contractual terms. Any discrepancies uncovered by this comparison are reported to the user.

This application claims priority under 35 U.S.C. 119(e) of the filing date of U.S. Ser. No. 60/573,917.

### BACKGROUND OF THE INVENTION

1. Field of the Invention

The present invention relates to automated data processing systems and methods for use in the health care industry, and in particular, a method for detecting and reporting the erroneous processing and adjudication of heath care claims and resulting payments made to a heath care provider by one or more third parties, such as medical insurance companies.

2. Background and the Prior Art

Domestic healthcare expenditures are reported to now amount to $1.3 trillion annually, accounting for more than 14% of the country's gross domestic product. This alarming statistic leads all other nations in both gross spending and proportionate allocation.

During the last half of the twentieth century, many employers added healthcare benefits, and associated insurance to existing and prospective employees as a means of differentiation among competitors, and in lieu of additional cash compensation. The practice was seen as a differentiating factor that would hopefully attract much needed gains in a scarce labor market responsible for driving the world's strongest and fastest growing economy.

Ironically, healthcare related benefits are now endangering the same economy through increased and accelerating costs. Because of the increase in health insurance cost, approximately 15% of the population, are now without these previously-offered benefits. This trend appeared to continue in 2003 as employers, or employees, chose to discontinue the practice of purchasing healthcare insurance.

The digression of “coverage” also has seeded another phenomenon commonly referred to within the industry as “subsidization”. The remaining insured portion of the population that maintains adequate healthcare insurance coverage, along with healthcare providers, must make up the shortfall for those who can't pay for their own healthcare costs either by burdening ever-increasing premiums, or through offering services on a charity basis. In short, those who can pay, will, and those who can cure, will.

The uninsured, including numerous illegal aliens, must be treated in accordance with EMTALA laws, which mandates the provision of care to all who seeks care within an Emergency Room setting regardless of patients' ability to pay. Although such mandates may be ethically sound, they also worsen cost acceleration by steering a significant portion of the population to settings where such care is most expensive. Under some circumstances, these laws appear to hobble poor patients by not creating solutions that provide access to intermediate care settings in a timely manner coinciding with the detection or onset of symptoms or injury, thereby lessening the need for future and more costly care in an emergent facility once their condition worsens to catastrophic levels.

As the economy began to react to the apparent healthcare cost increases, the Federal government, fueled by the same economy, correctly recognized the need to contain these costs within its own sphere of responsibility. The Centers for Medicare and Medicaid Services (CMS—previously referred to as Medicare) is saddled with the requirement to fund healthcare costs for the nation's aged and physically encumbered. In reacting to these increase, CMS decided to leave its resource pool at a fixed yearly dollar amount, rather than increase it due to the influx of Medicare newcomers, new technology, and expanded services, and ratchet down unit costs to all providers. This strategy, although correct from CMS's perspective, also heightened the effects of existing subsidization, in effect, adding yet another layer to the same problem.

The dramatic increases in healthcare costs stimulated by subsidization, are now catalyzed by two other primary forces, technology growth and the evolving healthcare transaction. These two other forces are unrelated in their genesis, but reciprocally linked by the effects of their growth. Both conditions are exacerbated by their environment—a dynamic and fast-paced economy.

Technological enhancements, developed during the latter half of the twentieth century, spurred some initial cost accelerations. Physicians, the centric force in the provision of healthcare, were ethically compelled and pseudo-legally driven to make use of such advancements for the benefit of their patients without regard to typical cost-benefit analyses and relationships enjoyed by other professions and industry segments. New diagnostic technologies including MRI's and PET scans are notable culprits. Unconventional therapies, although speculative and sometime questionable, also have presented for their allocation. As new technologies and therapies become known, those capable of affording insurance have demanded quick access to these new technologies and their capabilities.

During the advent of such advancements, the native domestic economy experienced explosive post-war economic and demographic growth unseen or experienced in other economies. As previously mentioned, the explosive growth led to increased labor demands on a moderately-sized work force. The imbalance led to a scarcity of labor, which in turn led to the offering of increased wages, and benefits, including health care insurance.

Healthcare insurers experienced dramatic increases during this time, and accordingly, mandated alterations to historical claim transaction policies to accommodate this growth. One critical alteration entailed shifting the responsibility of claim submission to insurance companies from the patients themselves to the healthcare providers. Past protocols required patients to submit standard claim reimbursement forms to insurers for reimbursement. As a result of accelerating transaction loads and ever-increasing transaction unit costs and complexities, certain healthcare transactions could not be competently filed or paid for by the average patient.

Subsequent to the transaction process shift, the healthcare market segmented further, thereby complicating transactions between inter-related services provided by physicians, hospitals, diagnostic laboratories, imaging centers, and ambulatory care and therapy centers. The segmentation dictated the need for insurers to maintain an orderly and qualified network of accessible and competent services within their geographic regions of commerce. In an effort to develop and maintain these networked services, insurance companies were compelled to develop “provider contracts”, which among other things, set forth certain terms and conditions governing access, quality, approval, eligibility and authorization processes, billing, and payment.

Quality standards employed in these provider contract agreements usually originated within standards established by the healthcare profession. Access and authorization limits and requirements usually resulted from standards typically employed or developed within the insurance industry. Billing and payment methodologies were created as a result of the contractual relationship itself. One example of such a methodology employed within provider contracts for physicians is CPT-4. CPT-4, or Current Procedural Terminology, fourth edition, was developed, and is maintained by the American Medical Association (AMA). CPT-4 consists of over 13,000 five-digit codes, along with over 30 associated two-digit modifiers, capable of describing and depicting almost every conceivable and currently accepted medical procedure. In addition, the AMA developed another code system, ICD-9,(International Classification of Diseases—9th revision) which further improves the efficacy of CPT-4 by linking a standard disease or diagnosis code with a resulting evaluation, management, or procedure code exhibited by CPT-4. Within CPT-4, which is updated quarterly, AMA affixes other symbols to each code to indicate the acceptability of combining, or not combining certain procedure codes within each immediate episode of care.

While the present invention is disclosed herein as being used in association with the CPT-4 medical billing and payment, the present invention is readily adaptable for use in connection with other billing and payment methodologies, and such alternative methodologies are expressly deemed within the scope of the present invention.

In an effort to standardize and streamline its ability to meet the growing claim adjudication demand, CMS adopted CPT-4 as its standard. CMS, the largest and most influential adjudicator of claims in the nation, added its effort-based reporting system containing RVU's (relative value units) to further recognize the impact of pricing, while at the same time adhering to the logic and methodology set forth by experts in the field, primarily the AMA. The two systems combined remarkably well, in large part due to the collaboration between the two entities, to yield a predictable and published methodology that served both users' need for predictability and consistency. The added RVU methodology allowed CMS to simply adjust its payment rate (commonly referred to as Conversion Factor) and apply the rate against existing effort units, which now are attached to each CPT code and modifier combination.

Faced with the same rising costs, commercial healthcare insurers embarked on their own cost containment strategy. Insurance companies began to create ways to control both access and cost. As previously mentioned, access controls were developed by the industry to reduce utilization (and therefore their costs), and remained primarily under the discretion of the industry. Such control can be seen in most provider contracts under related articles and sections pertaining to issues addressing adequate access, authorization procedures, certification procedures, prohibition against billing insured patients unjustly, and certain medical necessity rules pertaining to utilization of services. Interestingly, these same sections also incorporate the insurers' right to regularly update and adjust these rules at will, without the assent of or advance notice to the provider, through “incorporation by reference” to documents and publications commonly referred to as “provider manuals”.

Sections within provider contracts pertaining to billing and payment practices, however, usually require consent by both parties before changes, and are governed by descriptive rules exhibited in the previously mentioned CPT-4 codification.

While CMS continues to follow CPT-4, over the past 15 years, the commercial insurance industry has peculiarly strayed from adherence to these rules.

Such deviation is evidenced in the system disclosed in U.S. Pat. No. 5,359,509, dated Oct. 25, 1994 assigned to United Healthcare Corporation, one of the industries largest commercial insurers of healthcare costs. As stated in the disclosure, to reduce costs to insurers, submitted claims should be subjected to “review and adjudication” to minimize “fraud and unintentional errors and provide[s] consistency of payment for the same treatment”. Such a concept, employed by commercial insurers, appears duplicative to CPT-4 since “consistency” was a focal goal and cornerstone considered by the AMA in its development of CPT-4.

To assist insurance companies in their quest to minimize costs and review claims billed under CPT-4 for “consistency, the previously-mentioned patent introduces the insurance industry's concept of a “claims analyst.” A claims analyst, employed by a commercial insurer, as described within the patent, was trained for at least one year in claims terminology, and then given the responsibility to determine if a physician correctly interpreted and employed the correct medical terminology set forth under CPT-4 guidelines, which governed billing and collection transaction between the insurance company and the physician, and which had already been designed and tested for purposes of consistency. The analysts' charge was further heightened, within the patent, through assignment of the right to interpret “what is considered consistent for this procedure under current medical practice.”

Growing transaction volumes on these analysts gave birth to the concept of an automated “Health care payment adjudication and review system,” that in effect, automated the insurance industry's self appointed, and non-contractually sanctioned, analysts' responsibilities into an automated system suitable for use by those commercial entities responsible for paying healthcare claims, and incorporated the commercial insurers' corporate ethic for payment.

Unlike CMS's continued commitment to honor contractual terms, the commercial insurance market covering health care increasing elects to rely on its own automated systems, as exhibited in the previously mentioned patent, which enables potential users of such a system to make certain elections and adjudicate claim payments outside of the parameters set forth within CPT-4.

Because most healthcare providers were not as well equipped with current automated technology, these elections and deviations went unnoticed for a considerable period of time. Once healthcare providers intuitively detected these deviations through anecdotal relationships, technology within their grasp remained incapable of calculating, detecting and reporting such deviations for remedial action.

The present invention serves to compensate for such inadequacies by equipping healthcare providers with a conceptual framework and automated system capable classifying and quantifying such deviations in a systematic and comprehensive manner permitting a healthcare provider to operate its practice, monitor its interaction with insurance companies and insure that medical claims are accurately and timely paid in full compliance with existing contractual agreements.

Indeed, many healthcare providers have initiated lawsuits against some of the largest insurance companies, to recoup losses sustained as a result of these deviations. Insurance companies have been charged with using biased and dishonest methods for delaying, reducing, and even denying payments owed to healthcare providers by, among other actions:

1. Utilizing automated adjudication systems to improperly group codes (bundling);

2. Rejecting claims deemed medically necessary;

3. Overlooking or overtly ignoring CPT modifiers;

4. Using illegal business practices to reduce physician reimbursements, such as computer software programs that arbitrarily determine payment amounts and timing of payments, and even rejecting required payments to those providers unilaterally designated “high utilizers” by the commercial insurer;

5. Failing to abide by contract specific guidelines to pay providers in a timely and accurate fashion; and

6. Failing to disclose, and sometimes representing the non-existence of alternative methods used to compute payments to healthcare providers.

In an effort to obtain reimbursement from commercial insurers physicians often argue that such insurance company practices violate state and Federal statutes and common law premises concerning breach of contract.

Courts nationwide are ruling that healthcare providers, medical societies, and medical associations may proceed with these complaints. For example, the North Carolina Medical Society filed a suit against North Carolina Blues in January 2004 for the unlawful practices listed in items 1-6 above. In February 2004, a Cincinnati judge ruled that doctors may proceed with a lawsuit against Aetna Health Inc., Humana Health Plan of Ohio, Inc., United Healthcare of Ohio, Inc. and Anthem Blue Cross and Blue Shield. Due to Ohio's antitrust laws, it is likely that the doctors will be allowed to collect triple the amount of monetary losses they suffered as a result of these deviations. State medical associations in California, Georgia and Texas have partnered with providers in seven states in suing Aetna, Cigna, Coventry Healthcare, United Health Group of Minnesota, Health Net, Humana, Pacificare Health Systems and Wellpoint Health Networks.

While many suits are now entering the litigation process, others are reaching settlement. Once such suit, initiated by an Illinois physician, resulted in an award of all underpayments resulting from the alleged contractual deviation, along with assessed interest and associated legal fees.

Simply put, physicians are increasingly providing medical heath care services for their patients for which they are never paid. Physicians are increasingly finding themselves being forced to agree to fee limitations through agreed upon contracts with insurance companies, but also further withholdings and lost income through the illegal conduct of insurance companies as outlined above.

Unfortunately, many physicians in large and small communities alike are unwilling or unable to proceed against insurance companies in a legal forum. Moreover, it is not certain that such legal actions will ultimate succeed in completely reforming insurance company practices. Further, even if successful, a physician must endure the time and expense of pursuing litigation which in the end is unlikely to make the physician whole.

As a result, physicians are being paid less and less for their services, which coupled with ever increasing medical malpractice insurance costs, is likely to cause physicians to limit the types of services they provide their patients or drive them from practice altogether.

### SUMMARY OF THE INVENTION

The problems described above are in large measure solved by an Automated Erroneous Claims Payment System of the present invention, which compares each transaction recorded within a healthcare provider's automated accounting system with contractual terms set forth within individual contracts governing such transactions and with resulting payments received from third-party payors agreeing to the terms of the same contract. Through assimilation of critical data elements, the present invention detects, measures, and reports payment deviations not sanctioned by the particular and unique governing contracts and their relative terms and conditions.

Among the many benefits achieved by use of the present invention are:

Identifying erroneous payments to a health care provider resulting from a third party payor's failure to make accurate payment amounts in accordance contracts between heath care providers and such payors;

Identifying erroneous payment amounts resulting from the inaccurate use of certain assumptions or algorithms employed by third-party payors in adjudicating claims under the terms of said contracts where such methods do not comply or agree with contractual terms set forth in said contracts;

Identifying erroneous denial of payments, or withholdings or recoupments of payment, under terms, reasoning, or employed algorithms utilized by third-party payors that are foreign to, and not in accordance with, terms set forth in said contracts;

Identifying erroneous timing of payments, withholdings, or recoupments of payment, under terms reasoning or employed algorithms foreign to, and not in accordance with, terms set forth in said contracts; and

Identifying errors resulting from the combination of any or all of the foregoing deviations from the terms set forth in said contracts between health care providers and payors.

Accordingly, the present invention includes a method for detecting the erroneous processing and adjudication of health care claims and resulting payments received by a healthcare provider, or other recipient, under the terms of a third-party services contract. A computer processing system with database information is provided, including multiple databases which, among other information, discloses an inventory of table and field names, along with data types for each field, in a consistent and organized manner. The system further includes computer program utilizing code and query techniques which, amongst other information, discloses multiple query designs and configurations. The system detects and reports differences between provider billing and correct payment methodologies pursuant to a contract that is entered into between third-party payor and the healthcare provider under the following criteria:

Erroneous payments resulting from a third party payor's failure to make accurate payment amounts in accordance with the referenced contracts; erroneous payment amounts resulting from the inaccurate used of certain assumptions or algorithms employed by the third-party payor in adjudicating claims under the terms of the referenced contract where such methods do not comply or agree with contractual terms or referenced standards set forth in referenced contracts; erroneous denial of payment, or withhold or recoupment or payment, under terms, reasoning, or employed algorithms utilized by a third-party payor that are foreign to , and not in accordance with terms set forth in the referenced contracts; and erroneous timing of payments, withholds, or recoupments of payment, under terms reasoning or employed algorithms foreign to, and not in accordance with, terms set forth in the referenced contracts. Business rules logic is provided within the context of a rules engine that remains chronologically appropriate given the date such services were rendered on both a retrospective and prospective basis in accordance with the terms and standards set forth and referenced contracts, respectively, in the referenced contracts.

Accordingly, the present invention provides a means of reporting errors detected at various levels of aggregation when payments are not made by a third-party payor in accordance with the terms of the referenced contract

Although the illustrated embodiments relate in particular to the use of the present invention within the context of adjudicating health care claims pursuant to contracts between physicians and third-party payors such as insurance companies, the business rules logic of the present invention can also be tailored for use in any industry, in which, a third party contract exists with defined payment parameters, such as, for example, the record industry, auto insurance, litigation, banking institutions, etc. All these and many more have set fees, methods of payment, timeliness issues, and contracts that clearly defined how payments, denials and appeals should be handled. These can be monitored and adjudicated by the present invention.

### BRIEF DESCRIPTION OF THE DRAWINGS

FIG. 1 of the drawings is a block diagram of a contractual relationship between a healthcare provider and a third-party payor;

FIG. 2 of the drawings is a block diagram of the transaction flow in association with an automated electronic claims payment system;

FIG. 3 of the drawings is a block diagram of the present invention showing, in particular, the interaction of the rules engine with the client application and data;

FIG. 4 of the drawings is a block diagram showing the extraction of data from the payor file;

FIG. 5 of the drawings is a block diagram showing the extraction of data from the payment file;

FIG. 6 of the drawings is a block diagram showing the relationship between the rules engine, data warehouse, and external data;

FIG. 7 of the drawings is a block diagram showing the operation of the system engine;

FIG. 8 of the drawings is a screen capture of a client application of the present invention showing, in particular, a high level summary of processed claims;

FIG. 9 of the drawings is a screen capture of a client application of the present invention showing, in particular, a per-class summary for a calendar year;

FIG. 10 of the drawings is a screen capture of a client application of the present invention showing, in particular, a high level summary of all detected claim processing errors;

FIG. 11 of the drawings is a screen capture of a client application of the present invention showing, in particular, a high level summary of claim errors for an individual payor;

FIG. 12 of the drawings is a screen capture of a client application of the present invention showing, in particular, a detailed summary of claim errors detected for an individual payor;

FIG. 13 of the drawings is a screen capture of a client application of the present invention showing, in particular, the details of an individual adjudicated claim;

FIG. 14 of the drawings is a screen capture of a client application of the present invention showing, in particular, the determination of an error on the part of a payor; and

FIG. 15 of the drawings is a screen capture of a client application of the present invention showing, in particular, the analysis of a properly adjudicated claim by a payor.

### DETAILED DESCRIPTION OF THE INVENTION

While this invention is susceptible of embodiment in many different forms, there are shown in the drawing and will be described in detail, several specific embodiments, with the understanding that the present disclosure is to be considered as an exemplification of the principles of the present invention and is not intended to limit the invention to the embodiments illustrated.

Many of the difficulties described in the background above may in large measure be alleviated by the present Automated Claims Payment System. The Automated Claims Payment System compares each revenue/payment transaction, as recorded within a healthcare provider's automated information system, with industry standards and specific contractual terms governing such transactions. Through assimilation of critical data elements, the present invention detects, measures, and reports payment deviations not sanctioned by the particular and unique governing contracts and their relative terms, referenced standards, and conditions.

The assimilation mentioned directly above results from a multi-step process that combines and “links” critical data elements provided by the provider, the payor, the contract between the provider and the payor, and any referenced standards within the governing contract. The first step in the assimilation begins with capturing references to standards as contained within the governing contracts. Other terms such as claim filing and payment contestation time limits are manually captured and entered through a review of each enforceable payor contract. Payment amounts, usually appended to these contracts, are typically captured electronically either through optical character recognition devices, or through automated data transformation services. As with the extracted standards and the contract name, the payment amounts are also indexed to both the industry standard tables and the resident provider data system.

The second assimilation step is executed in a similar fashion through deploying available data transformation and conversion techniques to identify, transfer, and index relevant data residing within the provider's automated information system. All data is indexed and mapped using common database technologies to form a typical data warehouse capable of further and continual interaction with both the contract terms and the referenced industry standards as maintained locally, or within a database mechanism provided by the respective promulgating authority via the internet.

Procedure code “modifiers” common within the industry and the resident data system, can be either stored as two place character fields, or integer-based indices, for further interaction with the promulgating authorities' edit system. The interaction between the three data marts can be performed using standard OLAP (online analytical process) methodologies through deploying MDX (multi-dimensional expressions), or stored procedures available within common SQL (structured query language) stored procedures.

The invention uses both methodologies to execute individual algorithms (using either “if then” or “select case” methodologies) to systematically associate each “provider-resident” transaction, (typically consisting of specific data fields for the performing provider, date of service, place of service, payor, payor class, patient, procedure code and procedure modifier code(s) as indexed, with both the third-party contract requirements and the relevant fourth-party industry standard.

Each “algorithm” is performed in chronological order according the hierarchy set forth for each modifier and associated procedure code, as dictated by contract terms and referenced standards. Some of these algorithms are reliant upon its predecessor algorithm as dictated by the transaction type and its associated standards. The result set is then compared with payments actually recorded by the provider and then rendered through either standard database reporting systems, or through deployment of commonly used interfaces, to inform the provider-user of deviations from required results.

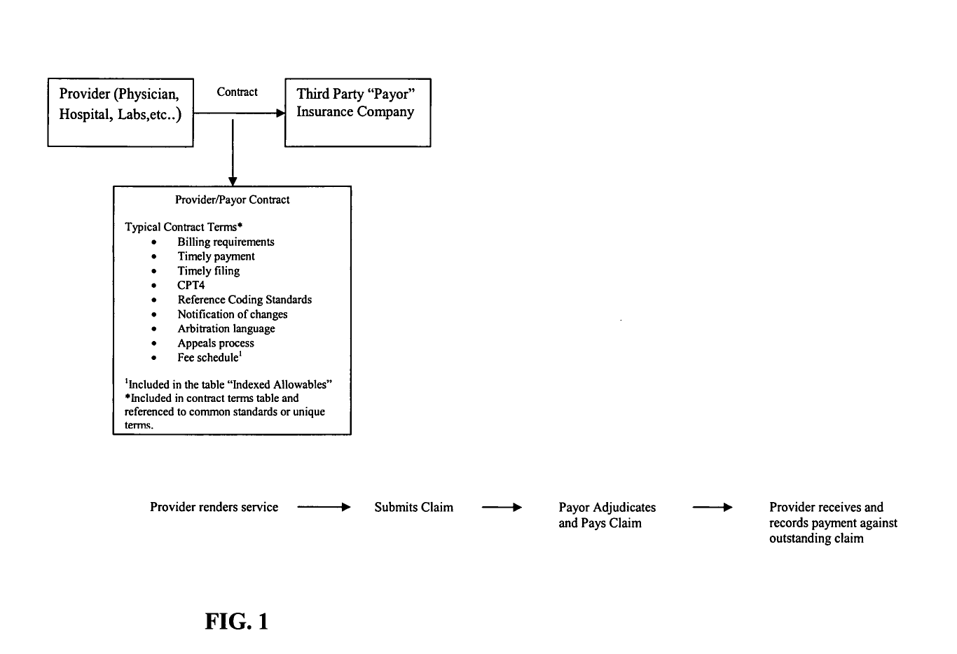

A typical contractual relationship between a healthcare provider and a third-party payor is shown in FIG. 1. Both parties gain value by solidifying their relationship under contractual terms. FIG. 1 depicts typical terms within such agreements. Particular portions of the typical contracts are loaded into the software component of the present invention for eventual use by the Automated Erroneous Claims Payment System. Such portions, or key elements, include, but are not limited to, the following: Billing Requirements; Billing and Payment Benchmarks (example CTP-4); Notification of Changes; Fee Schedule.

Provider and Payor desire to contract to ensure stable resources for each party to have enhanced value. Providers gain reliable source of patients and Payor is able to gain contracts by having a “provider network” that will accept their product in return for discounted reimbursement. Complexities peculiar to the healthcare industry result from permutations resulting from a variety of charge code combinations.

The present invention is readily adaptable for use with a multiple of payors (insurance companies) and the multitude of different contracts, programs, fee schedules, and procedures used to process health care claims. The foregoing elements may be entered into the present system manually or via an electronic data exchange.

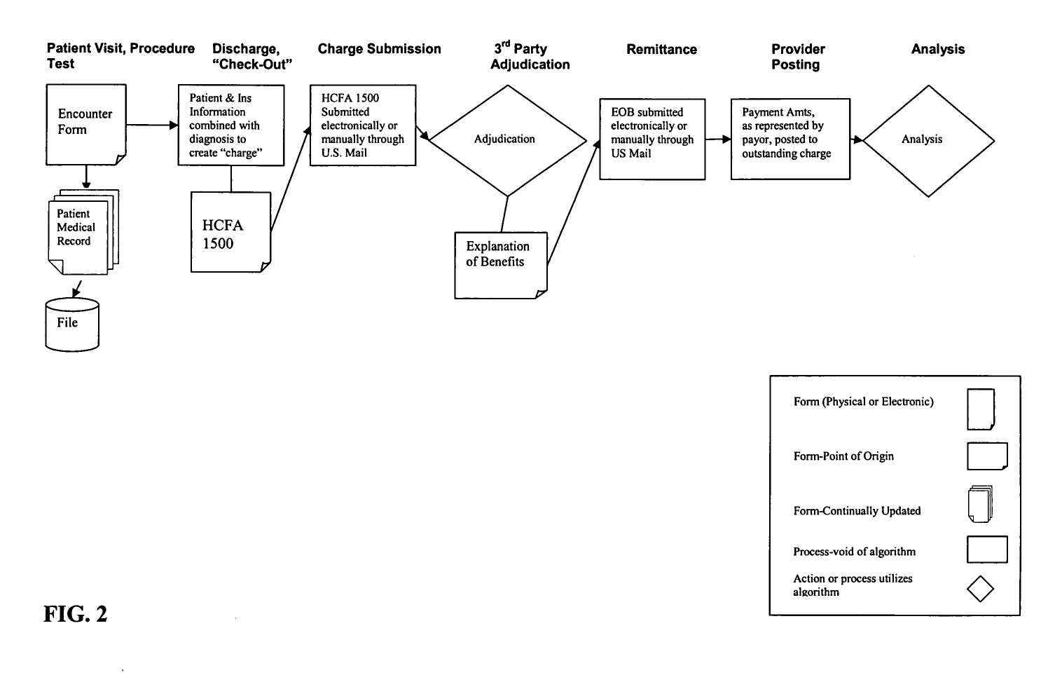

The critical data elements necessary for both parties to execute the healthcare transaction, along with chronological events and responsible parties are shown in the transaction flow diagram of FIG. 2, which depicts a typical health care claim process. The nature of each transaction will vary slightly based upon mandates or requirements within each provider/payor contract. Prior to a patient visit or procedure, this diagram assumes that Provider, Patient, and Payor have complied with all applicable terms and conditions governing such requirements (among other things) as eligibility, pre-authorization, and pre-certification.

The encounter form typically includes patient member, name and date of service, and physician records diagnosis using ICD-9 terminology

For illustrative purposes, a charge represents “one” charge or line item among multiple charges contained in a claim, ranked in descending order according to value. Each charge utilizes a CPT-4 code, and possibly up to 4 “modifiers”. As shown in FIG. 2, during adjudication, among other processes, the Payor verifies eligibility, complies with submission of claims methodology, and acceptability of code and modifier combinations under either a proprietary rules hierarchy, or under terms set forth by CPT-4 and ICD-9.

During provider posting, as shown in FIG. 2, a typical EOB will indicate specific payment information for each charge or line item within each claim. Typical EOB also indicates amounts allocated between Payor and Patient, along with an adjustment amount represented by the Payor as the difference between the original “charge” and the adjudicated allowable amount contained within the Payor/Provider Contract. Typically, most providers simply input payment and adjustment information, as represented by Payor on Payor's EOB, into its automated management information system without the ability to check accuracy of payment, allocation or variability resulting from use of modifiers or multiple charges.

During the analysis phase, as shown in FIG. 2, the Provider typically compares and reviews its accounts receivable, payments and charge data, along with associated payment tables appended to Provider/Payor Contracts, but is unable to detect or explain differences in payment terms resulting from exploitation by Payor of it proprietary process.

A hypothetical health care transaction, in which an erroneous payment by a payor is detected by the present invention, will now be described. During the “charge submission” step of FIG. 2, the procedure, in this case a surgery, was performed and billed on Jun. 10, 2004. The physician coded her steps using AMA's CPT-4 code 69433, “Typanostomy (requiring insertion of ventilating tube), local or topical anesthesia” (locally described by the physician as “create eardrum opening”). Because the physician performed this procedure “bilaterally” (“both ears”, she attached the bilateral modifier “50” to the claim.

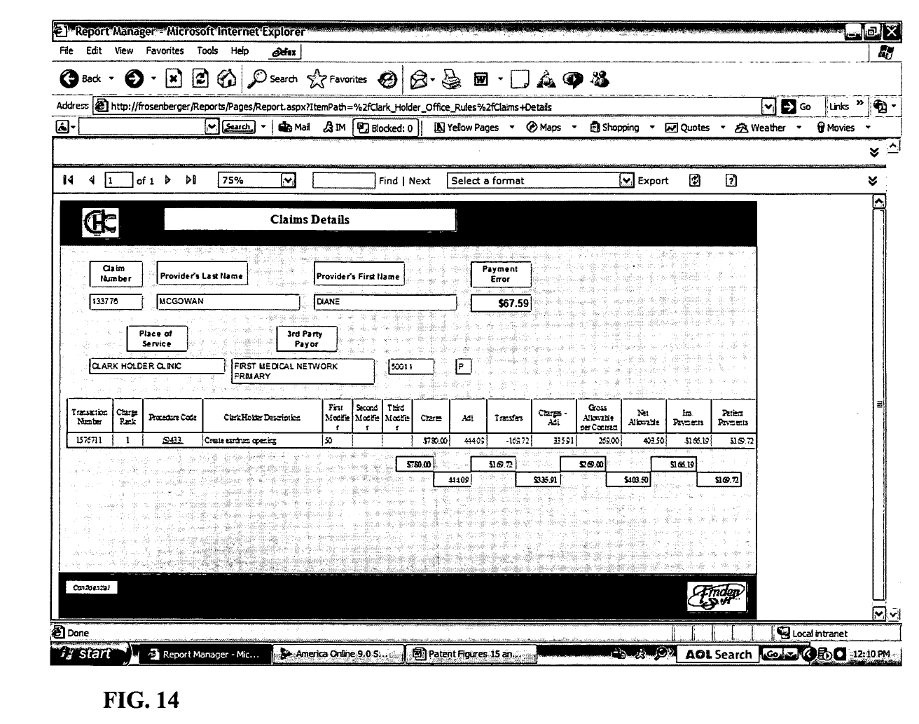

During the “third party adjudication” step of FIG. 2, on Jul. 27, 2004, the contracted third-party responsible for payment of the claim submitted its “EOB” (Explanation of Benefits) along with payment for its portion of the procedure's contracted price. The third-party “Payor” remitted a payment for $166.19 for its portion of the contracted price along with an EOB containing the following fields, also reflected in FIG. 14.

| | |
|---|---|
| Charge: | $780.00 |
| Adjustment to Charge: | (444.09) |
| Amount per Contract per Third | |
| Party Payor: | $335.91 |
| Insurance Payment: | $166.19 |
| Transfer for Patient Payment: | 167.72 |
| Total Payment: | $335.91 |

During the “provider posting” step of FIG. 2, the provider posted the information submitted by the Payor, via the above-referenced EOB, into its resident practice information system.

In the “analysis step” of FIG. 2, the Automated Erroneous Claims Payment System of the present invention extracts the information pertaining to the previously described charge and resulting payment on a daily basis via previously described methods. The system first compares the charge transaction with an edit table listing all allowable CPT-4 transactions and the associated local charge. The system then compares and extracts the contracted allowable amount by linking the third party payor index, as stored in the resident information system, with that Payor's table reflecting “allowables” as indexed to the same CPT code, in this case, 69433. Upon finding a match, the system continues with its stored procedure by locating a ‘50’ modifier in the first modifier field of the charge transaction and again comparing the acceptability of associating such a modifier with the specific CPT-4 code, under the current standards as represented by the AMA. After “linking” the procedure code with the previously described edit table, the system detects a “1” within the edit table's bilateral field for the 69433 code. Because the system also links a specific value and description table to the bilateral modifier field, it detects that a “1” represents “Bilateral Modifier Acceptable” along with the value of 50%. Had the CPT code 69433 contained a “2” in the bilateral field, the system would have detected that the code's value had been “reduced for bilateral modifier” and would not have increased the code's value for detection purposes.

After completing its stored procedure involving the review of all other modifier and contract fields, the invention renders a summarized view the form of FIG. 14. FIG. 14 is a screen capture of the hypothetical example described above with respect to FIG. 2. FIG. 14 represents the final rendering stage depicting the detected error, in this case $67.59. Because the contractually-owed amount, (reflected in the illustration as “Gross Allowable Per Contract”) was $269.00 without the ‘50’ modifier, inclusion of the same should have yielded a “Net Allowable” amount of $403.50 ($269.00×1.5). The total amount represented as due per the Payor's EOB (as entered into the resident information system) is $335.91 (“Charges—Adj.”) and allocated by the Payor to be paid by the Payor $166.19 and by the patient $169.79 (“Transfers”). The system maintains that the total amount due under this contract is $403.50 causing an error of $67.59.

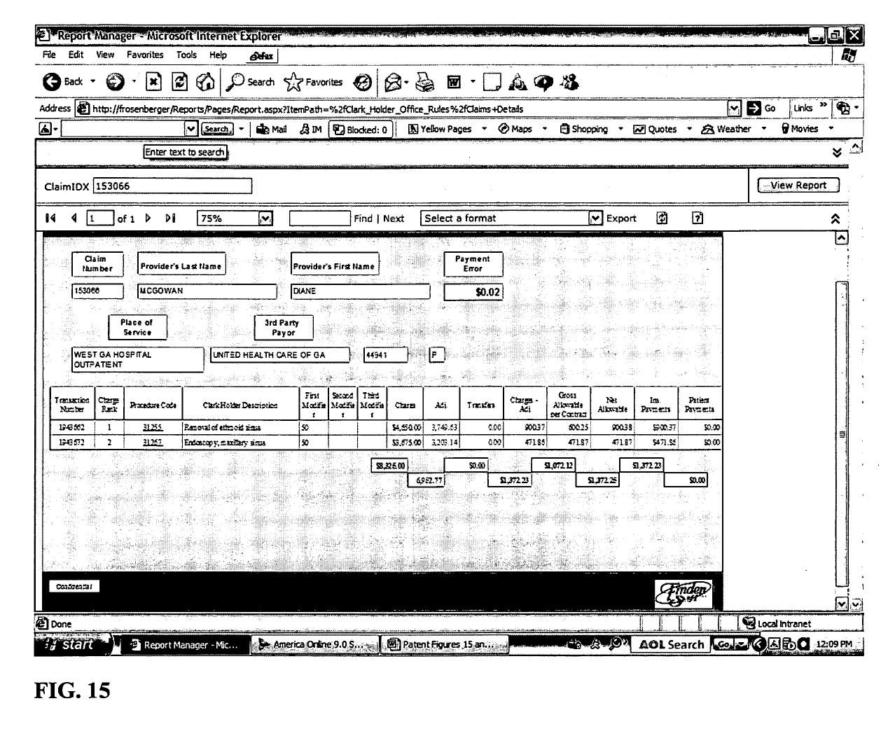

FIG. 15 depicts a similar hypothetical example, wherein another Payor adjudicated the ‘50’ modifier correctly. The resulting error shown in FIG. 15 is merely the result of mathematical rounding techniques that yield a difference of only 2 cents.

The example of FIG. 2 accordingly presents the creation, submission, adjudication and remittance of a physician transaction wherein the provider is a physician. This example is applicable to transactions executed by Hospitals, Labs, Imaging Centers, Physical Therapists and other providers subject to contractual relationships requiring submission and payment of “claims” under a common CPT-4 methodology employing HCFA 1500 or UB-92 claim forms.

Of course, a variety of physical platforms may be used to employ the present Automated Erroneous Claims Payment System. Potential platforms may include “stand alone” computer applications, networked computer processing systems commonly referred to as a “client-server” relationship, and “web-based” computer applications operating on either an “intranet” or “internet” basis. Moreover, a traditional three-tier architecture may be employed, including user interface, business logic, and data layers. For stand-alone applications, Microsoft Access may be used as a platform, supplying both the database (via the Microsoft JET engine) and user interface (forms). Alternatively, other databases, such as a stand-alone version (for desktop applications) or server-based version (for networked implementations) of Microsoft SQL Server, or an Oracle database, may be employed.

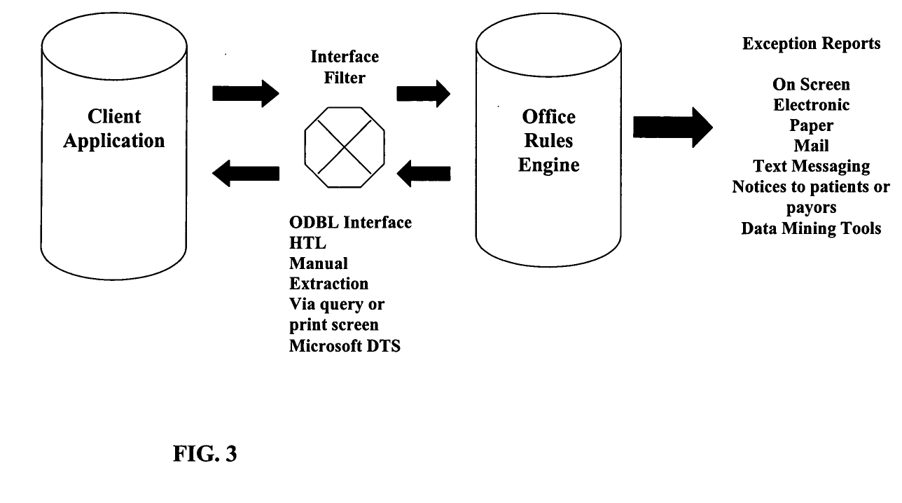

The interaction of the rules engine of the present invention with the client application and data is shown in FIG. 3. FIG. 3 illustrates the present invention's abbreviated process and actions, and also highlights various interface modalities through which critical data elements can be extracted from, or queried through, in applying the business rules logic within the Automated Erroneous Claims Payment System of the present invention.

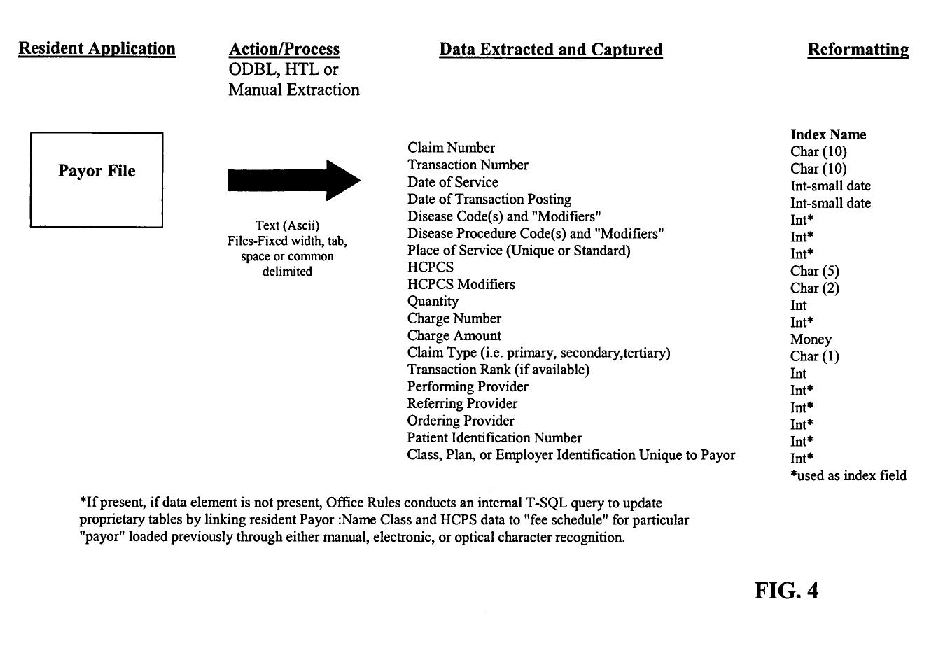

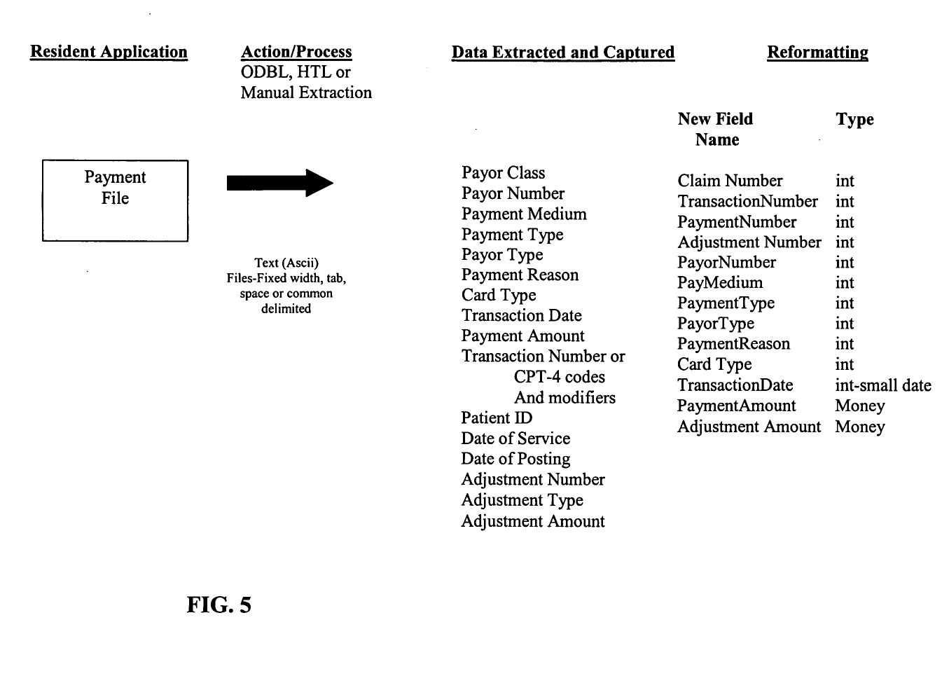

The extraction and capture of data from the extraction of data from a payor file for use by the present invention is shown in FIG. 4. The payment file is typically present within a resident application, such as a physician's office management system, and reflects the data that was submitted to third party payors in conjunction with the overall submission of claims, such as health care claims. Similarly, the extraction and capture of data from the extraction of data from a payment file for use by the present invention is shown in FIG. 5. Again, the payment file is typically present within a resident application, such as a physician's office management system, and is populated as payments, and associated explanations of benefits (EOBs), are received from third party payors.

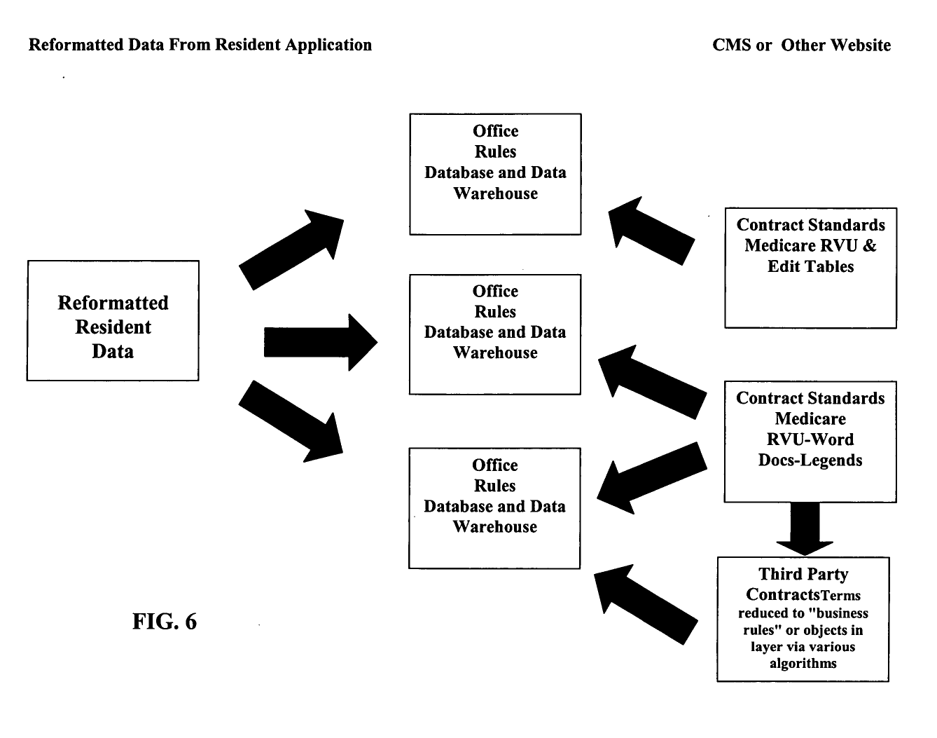

A block diagram depicting the relationship between the rules engine, data warehouse, and external data is shown in FIG. 6. resident data, typically from another resident software application associated with an automated electronic claims submission system, is reformatted, in accordance with FIGS. 4-5, into a data warehouse of the present invention. Contract standards, including the terms of specific contracts between the health care provider and third party payors, are reduced to business rules, or business objects, which reside within a business layer of a traditional three-tier software architecture within the present invention. As shown in FIG. 6, a cluster of multiple servers, each employing the rules engine (i.e., “office rules”) and each accessing and querying the contents of the data warehouse, may optionally be employed to speed system response in large-scale networked applications.

In particular, FIG. 6 shows the extracted and reformatted critical data elements, as housed within the various relational database tables of the data warehouse, and the insertion of the same into the business logic tables and queries necessary to complete certain mathematical algorithms in determining the required payment. The primary purpose of the business logic is to associate critical data elements, and their “key” fields, with status codes associated with benchmarked rules. In the example within this application, the “benchmark” used are the rules exhibited under CPT-4, and the status codes are codes associated with CPT-4 by the Center for Medicare Services (previously Medicare). These status codes are readily available at ww.cms.gov

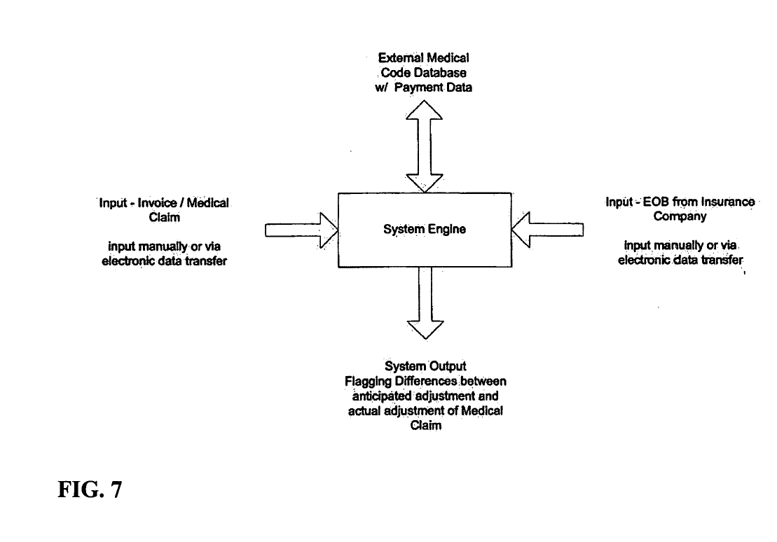

A diagram illustrating the operation of the system engine, which includes both the office rules engine and the data warehouse, is shown in FIG. 7. The system engine accepts medical claim submission and additional related information, via electronic transfer and associated reformatting, as previously described, or by full or partial manual data entry. The system engine further accepts, in either electronically submitted or manually entered form, explanation of benefits (EOB) from an insurance company or other third party payor. The system engine, using previously internalized business rules created in association with the specific third-party contracts under which claims and payments are made for individual payors, accesses external medical code databases and payment data for adjudicating each individual claim. Following the completion of the analysis of the EOB, in comparison with the medical code database and the underlying contractual terms, the system outputs an associated report, flagging any differences between the anticipated payment of the physician and the actual adjustment made for the medical claim by the third-party payor.

The flow of data in relation to the present invention is shown in FIG. 7. A physician invoice is input into the present system. The essential data is that which is contained in a medical claim form including patent data, date of service, relevant codes, such as CPT-4, and invoiced amounts. This data can be entered into the system manually by a clerk within a physician's practice or electronically through an electronic data transfer operation. In the later case, the data may be exported from a practice management system and downloaded into the present system. Alternatively, the present system can be electronically interfaced with the practice management system whereby the data from a medical claim is automatically input into the present system.

The central component of the present system is referred to as a system engine. In one embodiment of the present invention, the system is implemented using the Microsoft Access database software package. The engine is further shown linked to external database tables. These tables contain the various medical codes and corresponding payment data, such as CPT-4. Of course much more data may be contained therein. For example the individual medical insurance company contracts and their particular payment schedules and one or more coding methodologies may be stored therein. Evaluation and management codes and the like may be stored therein. These tables are further intended to remain current and are capable of independently being updated with the latest data from one or more medical insurance companies toward performing the automated analysis contemplated by the present invention.

When a medical claim is input into the system, the system is able to calculate an anticipated adjustment. This reflects the payment which is ultimately expected from the insurance company processing the particular claim. In short, the first step is calculating what should be paid to the health care provider.

The explanation of benefit (EOB) generated by the insurance company in response to a claim is input into the system. The data may be input manually or via electronic data transfer. The system is then made aware of what was paid on a given medical claim. The system engine then performs its analysis and generates an output which identifies the difference between the amount that was paid and the amount that was anticipated to be paid. The output can take many forms, including electronic data file, printed output and visual console display.

The system accordingly provides for the automated analysis of a health care provider's financial dealings with multiple third party insurance companies and multiple medical plans and payment schedules toward permitting the health care provider to easily monitor the insurance company's compliance with the terms of the various contracts therebetween which stipulate the payments to be made. Using the present system the health care provider can readily detect errors and even abuse by an insurance company in the payment of heath care claims.

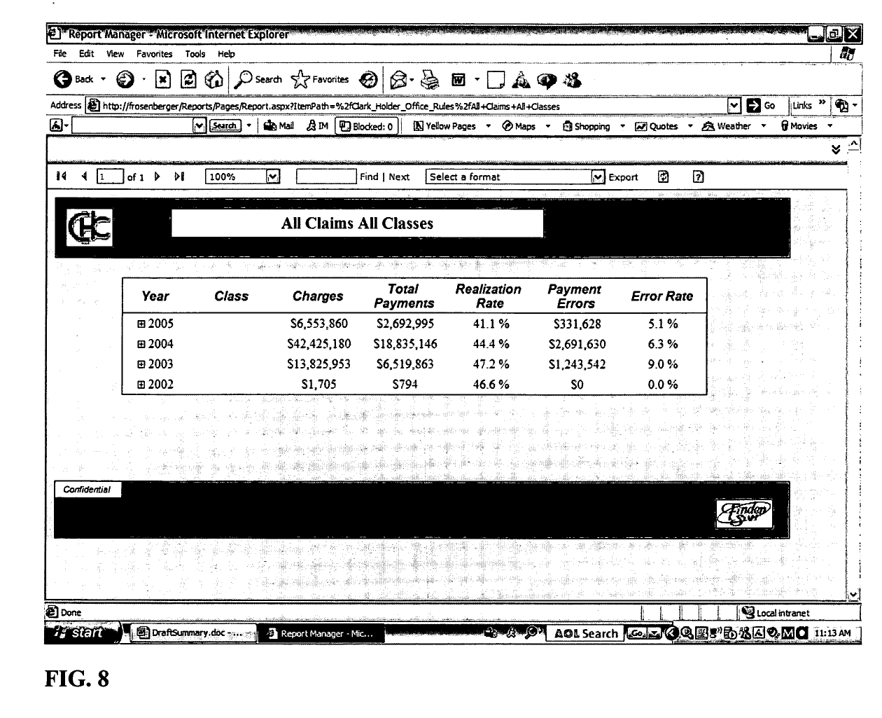

Sample user interface screen captures for the client component of the present invention are shown in FIGS. 8-13. Although a web browser-based client is shown in FIGS. 8-13, other graphical user interfaces, such as conventional desktop applications or Microsoft Access-based forms, may alternatively be employed. FIG. 8 depicts a per-year summary of all adjudicated claims for the calendar years 2002 through 2005. for each year, total charges made to payors, total payments received from payors, the realization rate (total payments received divided by total charges submitted), the aggregate amount of all payment errors detected by the present invention, as well as the error rate (payment errors divided by total payments).

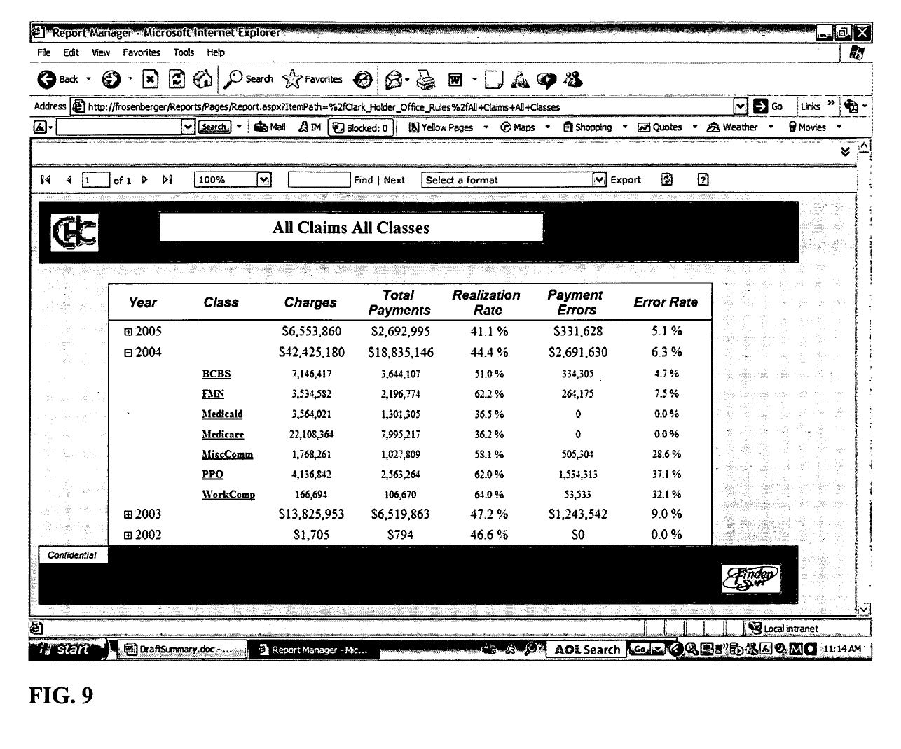

As shown in FIG. 8, in a preferred embodiment, the reports are presented in “drill-down” fashion. To the left of each depicted calendar year is an expand/collapse object. Clicking on one of these objects, such as the one to the left of the calendar year 2004, expands the associated year and causes per-class summaries of all adjudicated transactions within that calendar year to be displayed, as shown in FIG. 9. As shown in FIG. 9, classes or payors may include, for example, individual insurance agencies (BCBS), and governmental health care systems (Medicare, Medicaid).

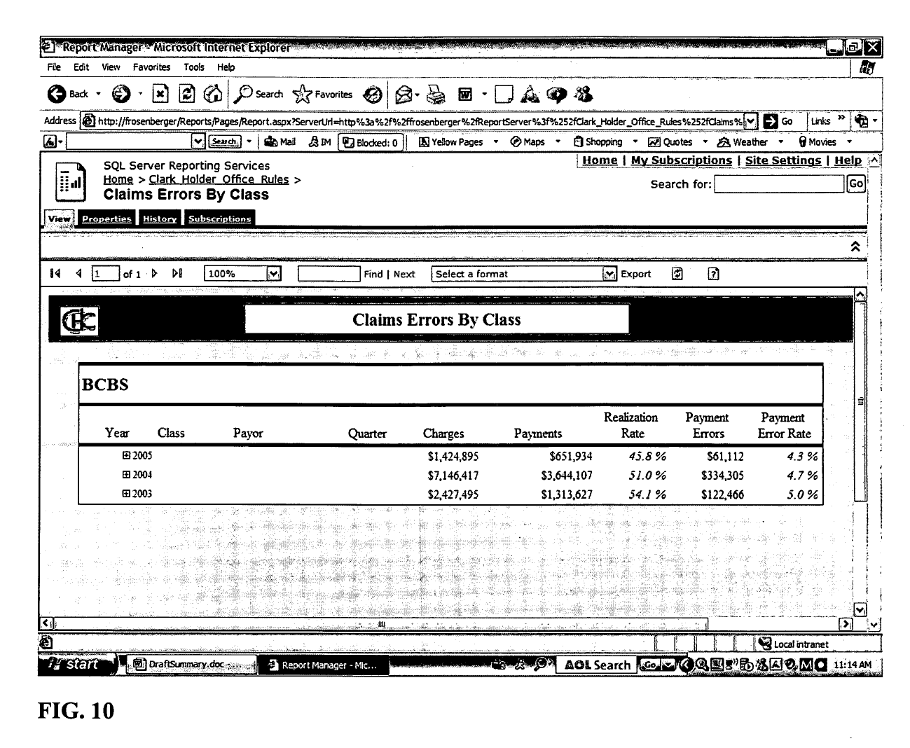

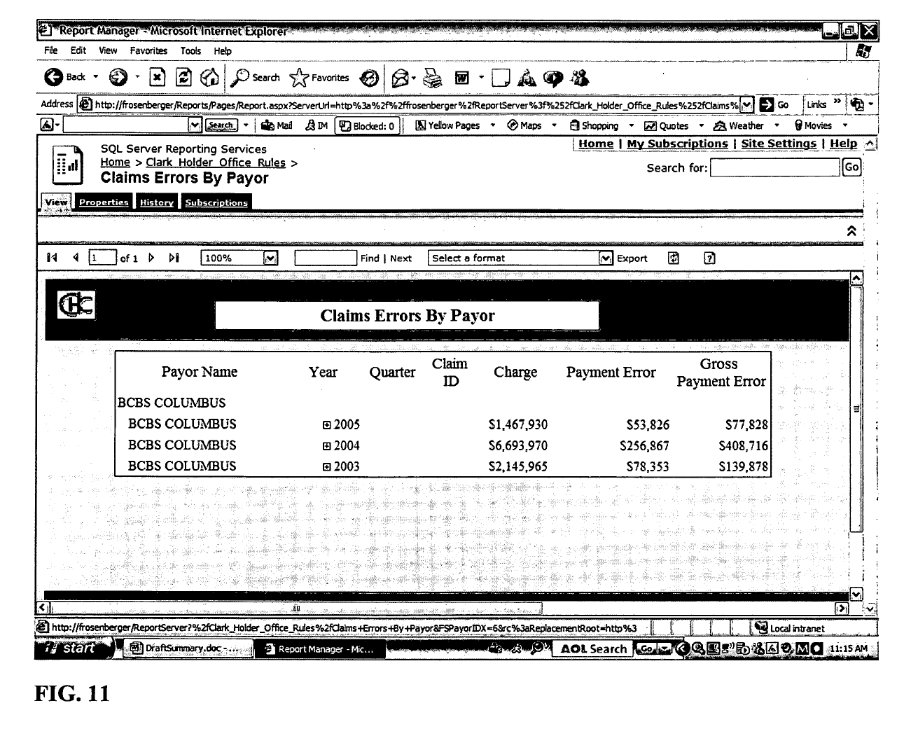

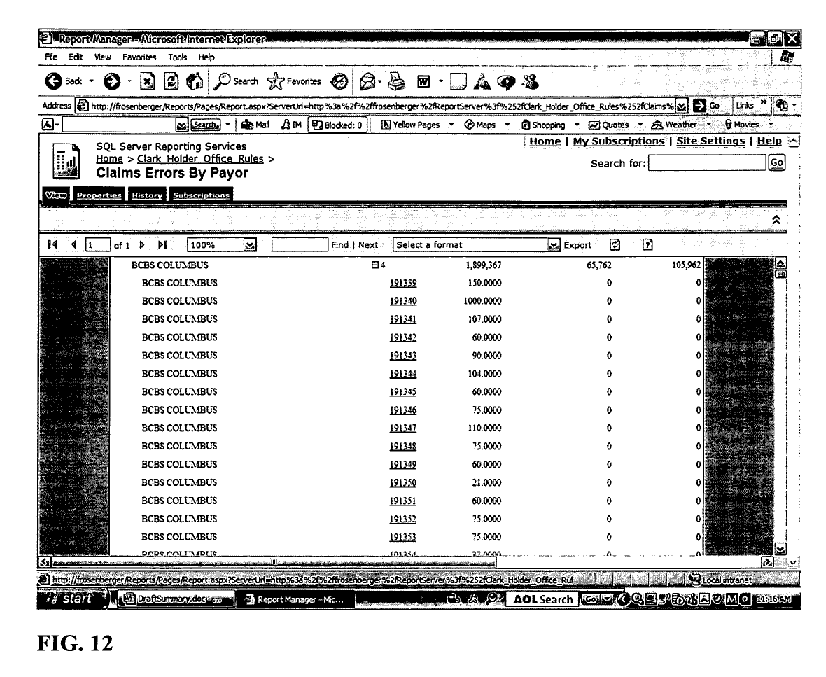

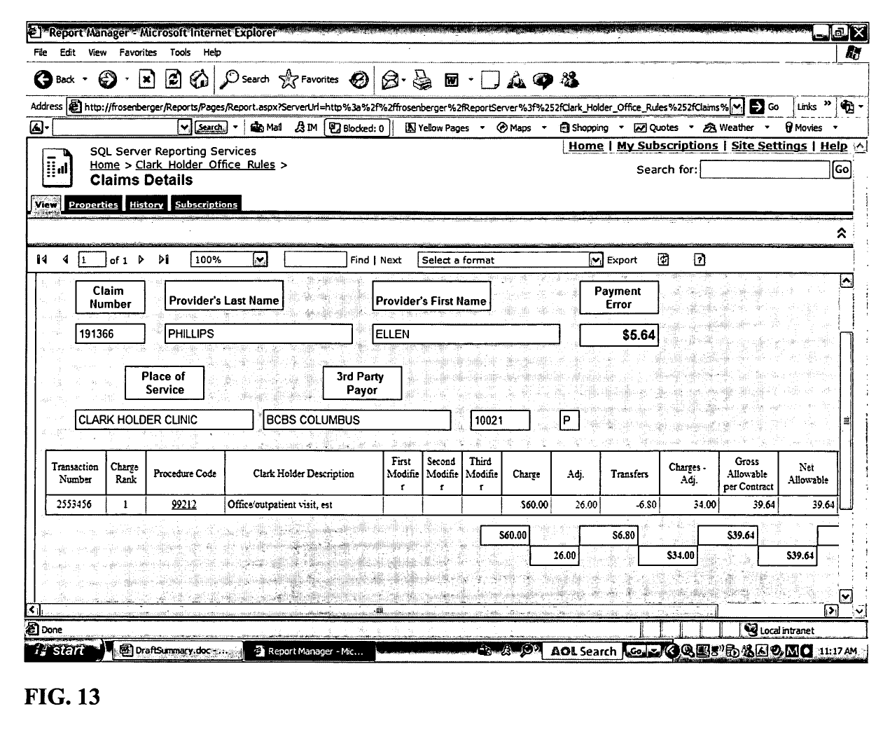

As shown in FIG. 10, the present invention also permits the presentation of payment error related information which, in a top level hierarchy of a drill down report, includes a summary of payment errors by calendar year. Moreover, claim errors may broken down, for reporting purposes, by individual payor, as shown in per-year summary in FIG. 11, and drilled-down, per-transaction (i.e., claim) summary within a particular calendar year, as shown in FIG. 12. Further, and as shown in FIG. 13, clicking on a hyperlink associated with a particular claim transaction of FIG. 12 results in the display of detailed information associated within the particular claim.

The foregoing description and drawings merely explain and illustrate the invention, and the invention is not limited thereto, except insofar as the appended claims are so limited as those skilled in the art having the present disclosure before them will be able to make modifications and variations therein without departing from the scope of the invention.

1. A method for detecting erroneous processing and adjudication of health care claims and resulting payments made by payor to a health care provider, comprising the steps of:
storing an electronic representation of a claim submitted from the health care provider to the payor;
storing an electronic representation of a payment and an explanation of benefits received by the health care provider;
storing an electronic representation of contractual terms entered into between the payor and the health care provider;
creating a set of business rules logic capable of comparing the electronic representation of the claim, the electronic representation of the payment and the explanation of benefits, and the electronic representation of the contractual terms;
applying the business rules logic to the electronic representation of the claim, the electronic representation of the payment and the explanation of benefits, and the electronic representation of the contractual terms to determine any discrepancies between the electronic representation of the claim and the electronic representation of the payment and the explanation of benefits in relation to the electronic representation of the contractual terms; and
reporting the discrepancies between the electronic representation of the claim and the electronic representation of the payment and the explanation of benefits in relation to the electronic representation of the contractual terms.
